(19) United States
(12) Patent Application Publication
(10) Pub. No.: US 2007/0157977 A1
(43) Pub. Date: Jul. 12, 2007

(54) Combined control shutoff valve and automatic shutoff mechanism for pressurized gas container

(75) Inventor: William C. Dean, Valley Park, MO (US)

Correspondence Address: GREENSFELDER HEMKER & GALE PC, SUITE 2000, 10 SOUTH BROADWAY, ST LOUIS, MO, 63102, US

(73) Assignee: Essex Industries, Inc., St. Louis, MO (US)

(21) Appl. No.: 11/639,032

(22) Filed: Dec. 14, 2006

Related U.S. Application Data
(60) Provisional application No. 60/750,117, filed on Dec. 14, 2005.

(51) Int. Cl. G05D 16/06

(52) U.S. Cl. 137/613

(57) ABSTRACT

A control assembly for use with a gas control body for a pressurized gas container provides both a selective gas control function and a safety shutoff function. A shutoff control member is selectively shiftable within the housing between flow-admitting and flow-closing positions. An automatic shutoff is carried by the shutoff control member for movement of the shutoff element in and out of sealing relationship relative to the inlet in response to gas pressure at the inlet, being responsive to gas pressure at the inlet to cause blocking flow from the inlet by the seat if inlet pressure is less than a predetermined cutoff pressure.

### CROSS-REFERENCE TO RELATED APPLICATION

This application is based upon and claims priority of United States provisional patent application invention Ser. No. 60/750,117 entitled Combined Control Shutoff Valve And Automatic Shutoff Mechanism For Pressurized Gas Container, filed Dec. 14, 2005, on behalf of the present inventor.

### BACKGROUND AND SUMMARY OF THE INVENTION

The invention relates to devices for control of gases released from pressurized gas containers such as oxygen cylinders, and more particularly, to a control assembly providing a combined shutoff control valve and automatic or safety shutoff mechanism for pressurized gas containers or so-called cylinders of the type used for supplying breathing oxygen.

Pressurized gas containers of the type used for supplying breathing oxygen are typically rechargeable. That is true, for example, of oxygen containers (often referred to commonly as medical oxygen cylinders and sometimes as “tanks”) used for supplying breathing oxygen for therapeutic or emergency use by a patient, and it is for therapeutic or emergency use by a patient, and it is also true of oxygen cylinders used for supplying breathing oxygen for use in aircraft.

For convenience herein, as used in connection with the concepts of control or shutoff of oxygen, other gases, and liquefied gases, the words “container”, “tank”, “cylinder” and “vessel” and the like are used interchangeably and equivalently.

Oxygen cylinders are commercially supplied for use in a filled condition, with breathing oxygen therein available at high pressure such as 2000 psig or more as, for example, a type filled to 300 bar (4350 psig). As oxygen from such cylinders is used over time, pressure decreases of course. If all the oxygen in such a cylinder were used, the cylinder would become exhausted and it would remain then at atmospheric pressure. But it is not desired that the cylinder be permitted to exhausted completely, so as to be at atmospheric pressure, as trace gases or contamination may enter the cylinder. Thus, it is known and may be required in some locations of usage or in some facilities that the cylinder not be permitted to be opened to atmosphere when exhausted but rather that some residual gas (e.g., oxygen) pressure be maintained therein. If the pressure is not lessened to atmospheric in the cylinder, there will be no need before refilling to pull a vacuum on the cylinder to remove any trace gases or contamination that otherwise may have been pulled into the cylinder.

Thus, low pressure cut-offs for gas cylinders have been proposed. This complicates known oxygen cylinder arrangements, especially in view of the consideration that such a cylinder must not also be equipped with a shutoff valve for providing pressure-related shutoff but also manual flow control for shutting off or enabling flow from the sensor.

Accordingly, among the several objects, features, advantages and utilities of the present invention are the provision of a combined shutoff combined shutoff control valve and automatic shutoff valve, that is, a safety shutoff mechanism, for pressurized gas containers (herein called by their more common name cylinders) of the type used for supplying breathing oxygen which mechanism or system
provides an improved low pressure cut-off.
combines a low pressure cut-off with the control elements of the control valve used for providing manual shutoff and manual flow control.
achieves an extremely compact, small and efficient dual cut-off and control function at a single location on such a cylinder.
integrates multiple functions of safety (automatic shutoff and gas control into a single assembly.
reduces the number of elements heretofore required to achieve the desired functions for such a cylinder.
reduces the complexity of such a cylinder.

provides for more economical manufacture of such cylinders.
provides an uncomplicated combination of required control and low pressure cut-off functions.
ensures with a high degree of reliability and precision that such a cylinder will never be opened to atmosphere when exhausted
ensures that, as such a cylinder nears exhaustion of its gas content that a certain residual gas (e.g., oxygen) pressure will be maintained.
ensures that gas pressure is the cylinder is never lessened to atmospheric, and so obviates any need before refilling to pull a vacuum on the cylinder in order to remove any trace gases or contamination that may have otherwise been pulled into the cylinder.

Briefly, a control assembly for use with a gas control body for a pressurized gas container provides both a selective gas control function and a automatic (or “safety”) shutoff function, and comprises a shutoff control member extending into a housing and selectively shiftable within the housing between flow-admitting and flow-closing positions relative to a gas inlet. An automatic shutoff insert is carried by the shutoff control member and includes a shutoff element for movement in and out of sealing relationship relative to a seat at the inlet in response to gas pressure at the inlet. The shutoff element is biased for closing movement so as to close if gas pressure at the inlet is less than a predetermined cutoff pressure. The shutoff control member is selectively operative to shift the automatic shutoff and the shutoff element for sealing of the inlet for blocking gas flow from the inlet, but if the shutoff control member is moved to a position for admitting gas flow, the automatic shutoff permits gas flow from the inlet only if gas pressure at the inlet is greater than the predetermined cutoff pressure, whereby, gas flow is automatically blocked from the inlet if pressure at the inlet is at any time less than the predetermined cutoff pressure so that the gas container is never permitted to drop below the predetermined cutoff pressure.

### BRIEF DESCRIPTION OF THE DRAWINGS

FIG. 1 is side elevation view, partly cut away, of a combined control shutoff valve and safety shutoff mechanism as incorporated in a regulator and control assembly for a pressurized gas container (tank), in accordance with and embodying the present invention.

FIG. 2 is longitudinal vertical cross section of portions of a regulator and control assembly, namely a safety shutoff mechanism. The shutoff mechanism in shown in closed position.

FIG. 3 is a longitudinal vertical cross section of portions of a regulator and control assembly, showing the shutoff mechanism in shown in open position to permit flow of gas to the regulator.

FIG. 4 is a longitudinal vertical cross section of portions of a regulator and control assembly, showing the shutoff mechanism in open position but with its automatic shutoff elements moved to a flow-closing position to block further flow of gas from the oxygen tank.

Corresponding reference characters indicate corresponding parts throughout the views of the drawings.

### DETAILED DESCRIPTION OF A PRACTICAL EMBODIMENT

Referring to the accompanying drawings, there is shown a regulator and control assembly generally designated A, which is referred to in this description simply as a regulator or assembly. Assembly A which includes is a combined control shutoff valve and safety shutoff mechanism according to the invention, generally designated B, and for convenience referred to as the shutoff mechanism. Assembly A is shown fitted to a conventional oxygen tank, i.e., and oxygen cylinder C of the type for storing breathing oxygen therein at high pressure such as 138 bar (2000 psig) or 300 bar (4350 psig).

The following parts list identifies various elements of the construction:

regulator assembly A combined control shutoff valve
and safety shutoff mechanism B

| oxygen cylinder | C |
|---|---|
| filter | 1 |
| body | 2 |
| body necked portion | 2n |
| threaded body recess | 2r |
| seat | 2s |
| dip tube | 3 |
| O-ring | 4 |
| O-ring | 5 |
| O-ring | 6 |
| backup ring | 7 |
| plunger assembly | 8 |
| seal-engaging member | 8e |
| sealing surface | 8s |
| plunger or piston | 8p |
| shutoff insert | 9 |
| seal-engaging member | 9e |
| wrench surfaces | 9f |
| shutoff insert threads | 9t |
| shutoff spring | 10 |
| shutoff housing | 11 |
| external threads | 11t |
| filter | 12 |
| fill fitting | 13 |
| insert, seat | 14 |
| ball | 15 |
| filter | 16 |
| O-ring | 17 |
| O-ring | 18 |
| pressure relief device | 19 |
| O-ring | 20 |
| O-ring | 21 |
| piston assembly | 22 |
| shim | 23 |
| guide with seal | 24 |
| 50 psig spring | 25 |
| flow selector | 26 |
| retaining ring | 27 |
| knob assembly | 28 |
| gasket | 29 |
| oxygen fitting | 30 |
| oxygen delivery tubing | 30t |
| pressure gauge | 31 |
| gauge protector | 32 |
| green handle | 33 |
| “Torx” screw | 34 |
| O-ring | 35 |
| lubricant | 36 |
| operating instructions | 37 |

Regulator body 2 has a necked portion 2n connected to cylinder or tank C by a such that oxygen is drawn from the cylinder through a the usual dip tube 3, and such oxygen when permitted to flow passes through a 150 micron filter designated as part number 1. Flow is controlled shutoff mechanism B. As according to the presently described features the shutoff mechanism allows manual shutoff or manual flow enabling, but also operates to cause automatic shutoff to the tank if oxygen pressure in the tank falls below a predetermined value such as 4 bar (58 psig) which would indicate that the tank oxygen content has been nearly emptied.

Cylinder or tank C is preferably of a commercial size designation to hold enough breathing oxygen for intended purposes, whether for being personally carried by a patient or by medical/rescue personnel.

Body has a handle 33 of sufficient strength and configuration illustrated to support and carry reliably both assembly A and filled cylinder C.

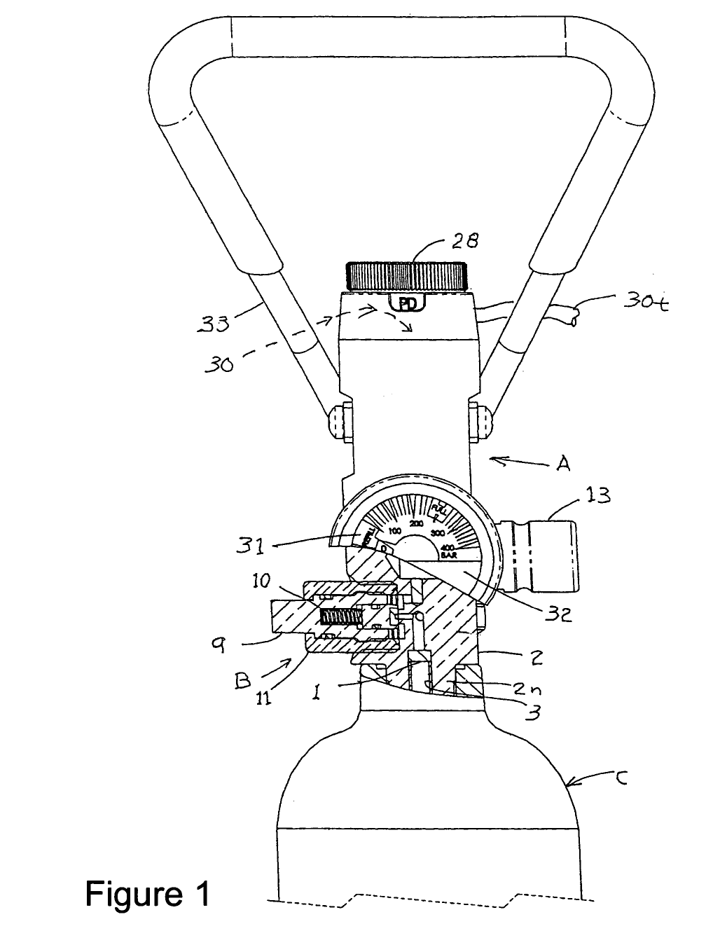

Body 2 incorporates an regulator per se (not specifically illustrated) of known type and the features of which are not of present concern. A control knob 28 allows selection of a desired oxygen flow rate, at regulated pressure, for delivery by a suitable oxygen outlet fitting 30 (hidden as being to the rear of the assembly of FIG. 1), to which may be fitted delivery tubing 30t for delivering oxygen to a user.

Extending laterally outwardly from body 2 perpendicular to its vertical axis is a fill fitting 13 for permitting conventional filling or refilling the tank.

A pressure gauge 31 extends from one side of body 10 to show tank pressure. A gauge protector 32 protects the pressure gauge from external damage, and may for example be of the configuration described in co-assigned U.S. Design Pat. D468,012.

Shutoff mechanism B is incorporated into regulator assembly A. It will be understood that the regulator is intended to regulate pressure, reducing pressure from, for example, 300 bar (4351 psig) to 50 psig and delivering it at such reduced pressure with accurate pressure regulation.

Shutoff housing 11 is threaded by external threads 11t into body 2, holding shutoff insert 9 captive, and an O-ring 6 maintains inner sealing in adjacent relation to a body seat 2s of a threaded recess 2r extending into body 2. Shutoff housing 11 has external threads which engage threads 9t of insert 9.

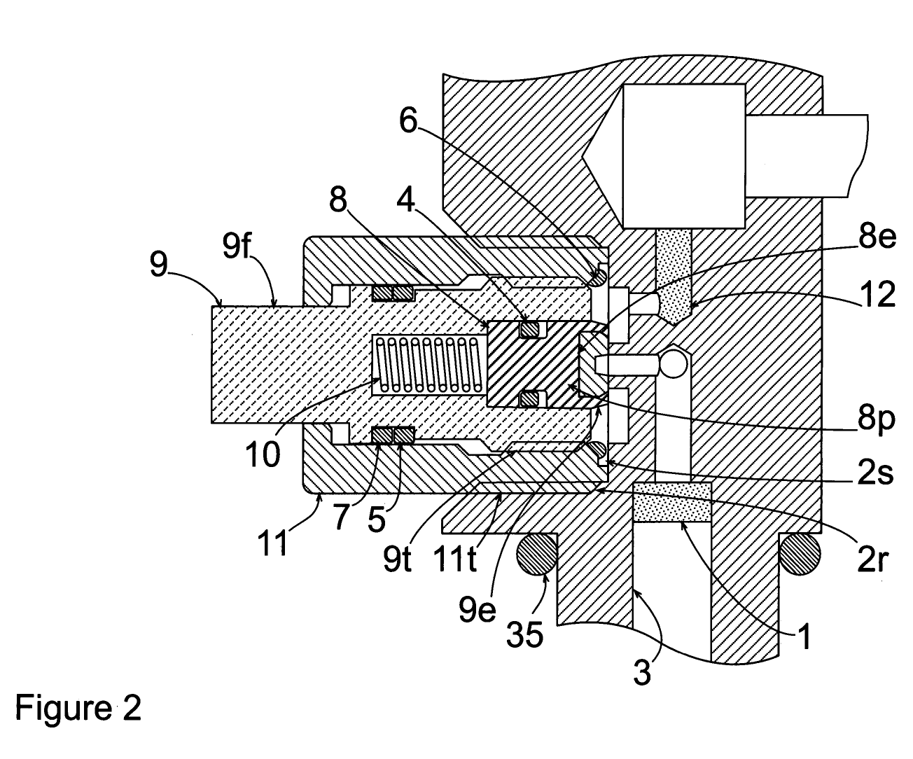

As shown in FIG. 2, when the shutoff mechanism is rotated so as to be moved by threads 9t into a fully closed position, the shutoff insert presses the shutoff piston assembly 8 against seat 2s preventing any oxygen from getting past. A standard wrench or knob of suitable type engages flats of wrench surfaces 9f to tighten or loosen the shutoff insert 9 and thus shift into and out, respectively, of its shutoff position, as will be seen. Thus, FIG. 2 best shows the shutoff mechanism in closed position.

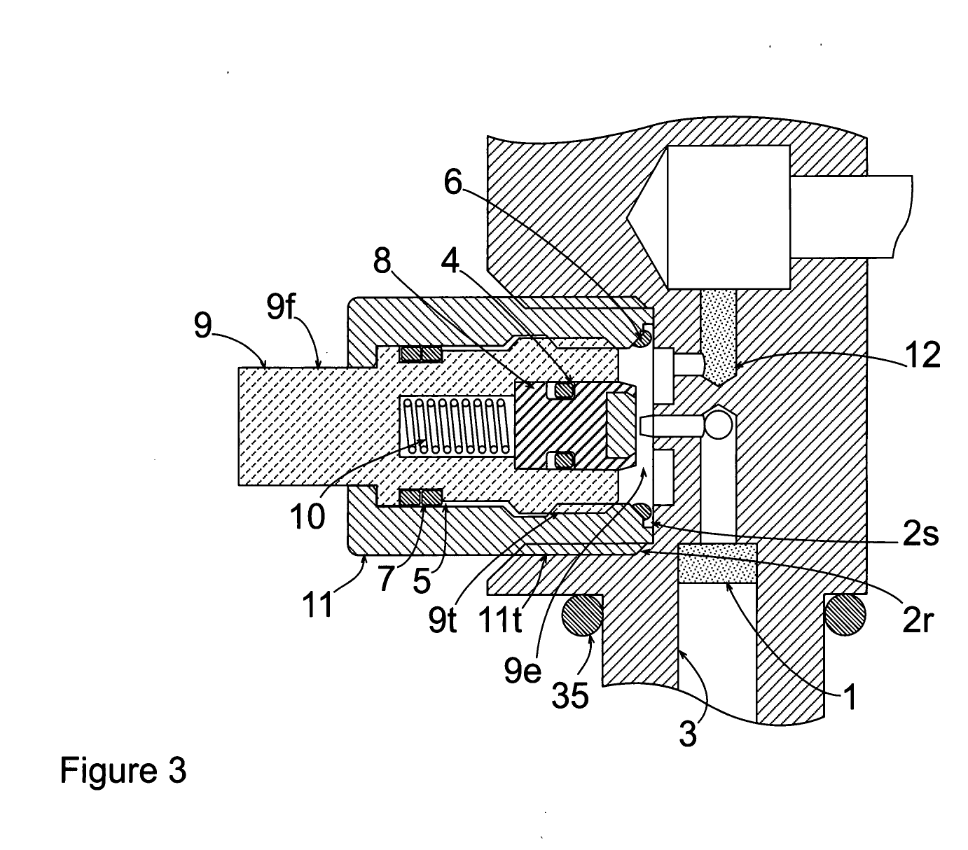

Automatic shutoff features may now be better understood from reference to FIGS. 2, 3 and 4, where, it is first noted that the shutoff assembly in shown in closed position. By comparison, in FIG. 3, the shutoff mechanism in shown in open position with the valve seat being opened to permit flow to the regulator.

Carried by the shutoff mechanism is a shutoff piston (that is, plunger) assembly 8 including a plunger or piston 8p which has a seal-engaging member 8e that is generally cylindrical and is axially shiftable within a bore 9b, being normally biased inwardly by a compression spring 10 so as tending to cause seal-engaging member 9e to move toward a sealing relation with seat 2s unless there is sufficient minimum or greater tank pressure, in which case the seal-engaging member is caused to shift sufficiently outwardly to permit gas to enter through a passage 1p so as to pass between a seat-engaging seal position and seat 2s if permitted by shutoff insert 9. An O-ring 4 maintains a gas-tight relationship of the plunger or piston 8p within its bore.

When the shutoff insert is backed away from seat 2s, as shown in FIG. 3, oxygen is allowed to pass the seat so long as the force due to its pressure is greater on the exposed face is greater than the force of the spring 10 behind the shutoff piston assembly.

Once past seat 2s the high pressure oxygen is then regulated down to 50 psig by the regulator assembly and restricted to an appropriate flow rate (as set by knob 28) suitable or prescribed for the patient.

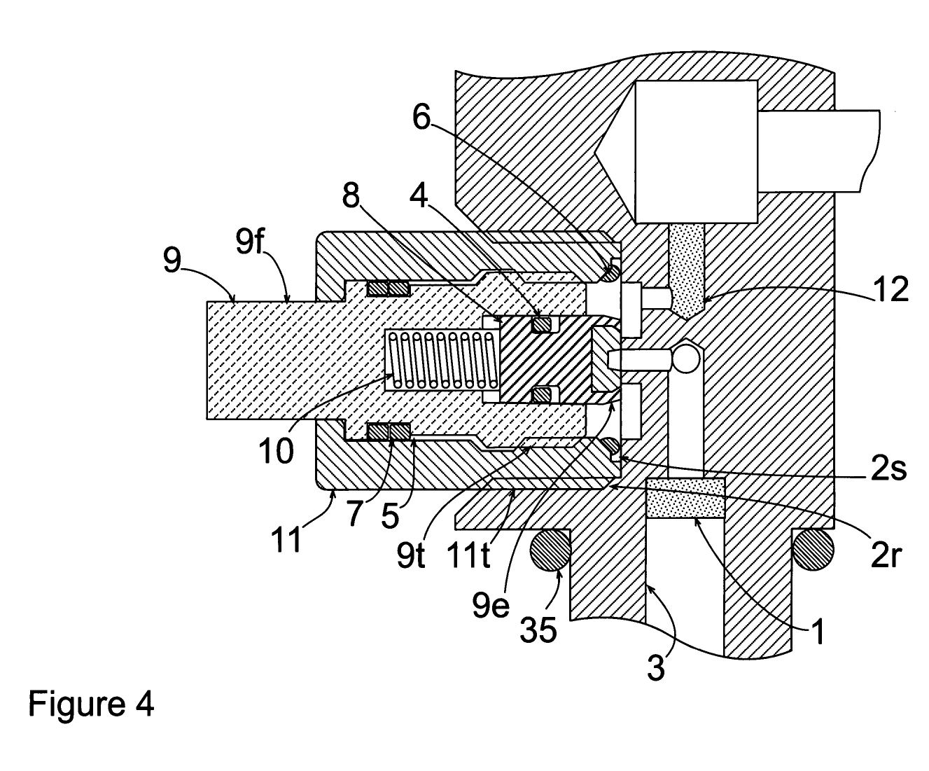

Even though shutoff insert 9 may remain in an open position, as in FIG. 3, when gas in tank C is nearly used up, as the pressure in the tank lessens to 4 bar (58 psig), spring 10 behind shutoff piston or plunger assembly 8 creates a seal at the seat, thereby keeping the remaining gas in the cylinder. Such sealing movement of the shutoff piston assembly results in the position of components shown in FIG. 4. Thus, in FIG. 4, the shutoff mechanism in shown in open position but the valve seat is closed by the automatic shutoff piston or plunger assembly 8.

As a result, when tank C is then to be refilled by use of refill fitting 13, it will not be necessary to pull a vacuum on the system to remove any trace gases or contamination that may have otherwise been pulled into the cylinder, since the pressure is never lessened to atmospheric in the tank. Oxygen in the tank thus remains therein always at a pressure greater than atmospheric.

Accordingly, it is seen that the present invention provides a control assembly for use with a gas control body for a pressurized gas container, for providing both a selective gas control function and an automatic safety shutoff function, the assembly comprising:

a gas inlet for providing gas under pressure from such a gas container to the control assembly;

a housing in mating relationship with the gas control body;

a shutoff control member in axial relationship within the housing;

the shutoff control member being selectively shiftable within the housing between flow-admitting and flow-closing positions;

the control member including a control engagement portion presented for selectively rotating the control member to cause it to be shifted along the control axis between a flow-admitting position and a flow-closing position;

an automatic shutoff member carried by the shutoff control member;

a seat is presented adjacent the automatic shutoff member for sealing relationship relative to the inlet when the automatic shutoff member is urged in one direction relative to the inlet;

a biasing device carried by the automatic shutoff biases the automatic shutoff member in said one direction for sealing movement against the seat to provide a sealing relationship relative to the inlet for blocking gas flow from the inlet if pressure of gas at the inlet is less than a predetermined cutoff pressure;

the shutoff control member being operative to shift the automatic shutoff for causing the shutoff control member to provide a sealing relationship relative to the seat at the inlet for blocking gas flow from the inlet if the shutoff control member is shifted to its flow-closing position; and

the shutoff control member being operative to shift the automatic shutoff for causing the shutoff control member to be enabled to move away from its sealing relationship against the seat relative to the inlet for permitting gas flow from the inlet if the shutoff control member is shifted to its flow-admitting position but only if gas pressure at the inlet is greater than the predetermined cutoff pressure; and

whereby gas flow is permitted, unless selectively cutoff by the shutoff control member, only so long as pressure of gas at the inlet is greater than the predetermined cutoff pressure, but gas flow is automatically blocked from the inlet if pressure at the inlet is less than the predetermined cutoff pressure.

As is seen, the shutoff control member is selectively shiftable along a control axis within the housing by selective rotation within the housing between the flow-admitting and flow-closing positions.

In view of the foregoing description of the present invention and embodiment, it will be seen that the several objects of the invention are achieved and other advantages are attained.

As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. A control assembly for use with a gas control body for a pressurized gas container, for providing both a selective gas control function and an automatic shutoff function, the assembly comprising:
a gas inlet for providing gas under pressure from such a gas container to the control assembly;
a housing in mating relationship with the gas control body;
a shutoff control member in axial relationship within the housing;
the shutoff control member being selectively shiftable within the housing between flow-admitting and flow-closing positions;
the control member including a control engagement portion presented for selectively rotating the control member to cause it to be shifted along the control axis between a flow-admitting position and a flow-closing position;
an automatic shutoff member carried by the shutoff control member;
a seat presented adjacent by the automatic shutoff member for sealing relationship relative to the inlet when the automatic shutoff member is urged in one direction relative to the inlet;
a biasing device carried by the automatic shutoff to bias the automatic shutoff member in said one direction for sealing movement against the seat to provide a sealing relationship relative to the inlet for blocking gas flow from the inlet if pressure of gas at the inlet is less than a predetermined cutoff pressure;
the shutoff control member being operative to shift the automatic shutoff for causing the shutoff control member to provide a sealing relationship relative to the seat at the inlet for blocking gas flow from the inlet if the shutoff control member is shifted to its flow-closing position; and
the shutoff control member being operative to shift the automatic shutoff for causing the shutoff control member to be enabled to move away from its sealing relationship against the seat relative to the inlet for permitting gas flow from the inlet if the shutoff control member is shifted to its flow-admitting position but only if gas pressure at the inlet is greater than the predetermined cutoff pressure; and
whereby gas flow is permitted, unless selectively cutoff by the shutoff control member, only so long as pressure of gas at the inlet is greater than the predetermined cutoff pressure, but gas flow is automatically blocked from the inlet if pressure at the inlet is less than the predetermined cutoff pressure.

2. A control assembly according to claim 1, the shutoff control member being selectively shiftable along a control axis within the housing by selective rotation within the housing between the flow-admitting and flow-closing positions.

3. A control assembly according to claim 2, the automatic shutoff member being carried by the shutoff control member in coaxial relationship therewith concentrically about the control axis.

4. A control assembly according to claim 2, the control member including a control engagement portion presented for selectively rotating the control member to cause it to be shifted along the control axis between its flow-admitting position and a flow-closing position.

5. A control assembly according to claim 3, the shutoff member and automatic shutoff member being shifted along the control axis, with said automatic shutoff member being moved toward the inlet against said seat for flow closing operation either in response to selective operation of the shutoff control member or automatically in response to the biasing means if pressure of gas at the inlet is less than the predetermined cutoff pressure.

6. A control assembly according to claim 3, the housing being in threaded mating relationship with the gas control body and the shutoff control member being in threaded in mating axial relationship within the housing.

7. A control assembly for use with a selective gas control body for a pressurized gas container for providing both a gas control function and a safety shutoff function, and comprising:
a shutoff control member extending into a housing and selectively shiftable within the housing between flow-admitting and flow-closing positions relative to a gas inlet;
an automatic shutoff device carried by the shutoff control member and including a shutoff element for movement in and out of sealing relationship relative to the inlet in response to gas pressure at the inlet,
the shutoff element being responsive to gas pressure at the inlet to cause blocking gas flow from the inlet by the seat if pressure of gas at the inlet is less than a predetermined cutoff pressure;
the shutoff control member being selectively operative to shift the automatic shutoff and the shutoff element for causing the seat to provide a sealing of the inlet for blocking gas flow from the inlet but permitting gas flow from the inlet only if gas pressure at the inlet is greater than the predetermined cutoff pressure;
whereby gas flow is automatically blocked from the inlet if pressure of gas at the inlet is at any time less than the predetermined cutoff pressure.

8. For use with a gas control body for a pressurized gas container, a control assembly for providing both a selective gas control function and a safety shutoff function, the control assembly comprising:
a housing;
a gas inlet within the housing for providing gas under pressure from such a gas container to the control assembly;
a shutoff control member extending into the housing and selectively shiftable within the housing between flow-admitting and flow-closing positions, the flow-admitting position permitting gas flow through the inlet and the flow-closing position preventing gas flow through the inlet;
an automatic shutoff carried by the shutoff control member;
a shutoff element of the automatic shutoff capable of movement in and out of sealing relationship relative to the inlet in response to gas pressure at the inlet;
the shutoff element being responsive to gas pressure at the inlet to cause blocking gas flow from the inlet by the seat if pressure of gas at the inlet is less than a predetermined cutoff pressure;
the shutoff control member being operative to shift the automatic shutoff and the shutoff element for causing the seat to provide a sealing relationship relative to the inlet for blocking gas flow from the inlet if the shutoff control member is shifted to its flow-closing position; and
the shutoff control member being operative to shift the automatic shutoff for causing the seat to be enabled to move away from its sealing relationship relative to the inlet for permitting gas flow from the inlet if the shutoff control member is shifted to its flow-admitting position but only if gas pressure at the inlet is greater than the predetermined cutoff pressure; and
whereby gas flow is permitted, unless selectively cutoff by the shutoff control member, so long as pressure of gas at the inlet is greater than the predetermined cutoff pressure, but gas flow is automatically blocked from the inlet if pressure of gas at the inlet is less than the predetermined cutoff pressure.
